(19) United States
(12) Patent Application Publication
(10) Pub. No.: US 2004/0170289 A1
(43) Pub. Date: Sep. 2, 2004

(54) Audio conference system with quality-improving features by compensating sensitivities microphones and the method thereof

(76) Inventor: Wen Jea Whan, La Puente, CA (US)

Correspondence Address: TROXELL LAW OFFICE PLLC, SUITE 1404, 5205 LEESBURG PIKE, FALLS CHURCH, VA, 22041, US

(21) Appl. No.: 10/373,838

(22) Filed: Feb. 27, 2003

(51) Int. Cl. H04R 3/00; H04M 3/42

(52) U.S. Cl. 381/92; 379/202.01

(57) ABSTRACT

An audio conference system with the quality-improving features by compensating sensitivities of microphones was developed to increase the exercise range of microphones and greatly improve the output quality. The audio conference system includes a microphone array, which is consisted of at least three microphones with known locations, a converter, which digitizes analog signals, a processor, two digital gain controls, and a digital compensation software. The quality-improving advantage is obtained by the method that the travel time differences form voice source to the respective microphones are distinguished, that the location of the voice source is calculated and located and that particular microphones are selected for compensating the sensitivity. Consequently such an Audio Conference System would allow a conference held in a large space and with multiudinous conferees, and be usable for remote conference through phone, Internet or other communication method.

### BACKGROUND OF THE INVENTION

1. Field of the Invention

The present invention relates to an audio conference system and more particularly, to a system automatically improving audio quality by compensating the sensitivity of particular microphone(s) due to the distance between voice source and the microphones. The audio conference system is usable for a conference held in large space, or for remote conference through phone, internet or other communication method.

2. Description of the Prior Art

In an audio conference system, the sensitivity of microphones differs from that of human ears with respect to the distance from voice source. As the distance from voice source become longer, the sensitivity of habitually use microphones becomes much weaker than that of human ears.

Multiple microphones for audio conference were disclosed in U.S. Pat. No. 5,848,146 where a controlled microphone mixer was used. Said microphone mixer includes a mixer output, a plurality of microphone input channel devices which receive and detect audio signals at proximal microphones, means for selectively gating on each of said microphone input channel devices in response to the audio signals and controlled channel thresholds, and signal summing devices for combining gated microphone input channel signals from said input channel devices into said mixer output.

### SUMMARY OF THE INVENTION

The primary object of the present invention is to provide an audio conference system, which can increase the dynamic range of the microphones.

Another object of the present invention is to provide an audio conference system, with which a speaker can make his speech anywhere instead of staying behind a microphone.

A further object of the present invention is to provide an audio conference system, with which the quality and intensity of signal output will be maintained, or even improved, regardless of the distance between a speaker and the microphone.

A further object of the present invention is to provide an audio conference system, with which a conference can be held with high audio quality which is not limited by large space or multitudinous conferees.

A further object of the present invention is to provide an audio conference system, which brings the remote conference through phone, internet or other communication method into a true conferencing environment.

A further object of the present invention is to provide a quality-improving method for audio conference by compensating sensitivities of microphones, with which the efficacy of microphones is much more improved.

A further object of the present invention is to provide a quality-improving method for audio conference by compensating sensitivities of microphones, with which the audio quality of a conference is ameliorated a lot.

Still a further object of the present invention is to provide quality-improving method for audio conference by compensating sensitivities of microphones, with which an audio conference can be held with no restriction against locations of speakers and distance between conferees.

In order to achieve the above-mentioned object, the audio conference system includes a microphone array, which is consisted of at least three microphones with known locations, a processor, a converter which digitizes analog signals, two digital gain controls, and a digital compensation software. The quality-improving advantage is obtained by the method that the travel time differences from voice source to respective microphones are distinguished by a high-speed analogue to digital converter, that the location of the voice source is calculated form the algorithm in terms of the travel time differences and is represented by the distance and the directional angle and that the directional angle is then used to calculate the necessary gain of the microphone to recover the sensitivity of the microphone(s).

The present invention will be apparent in other features after reading the detailed description of the preferred embodiment thereof in reference to the accompanying drawings.

### BRIEF DESCRIPTION OF THE DRAWINGS

FIG. 1 is a schematic view of the first embodiment of the present invention, in which three microphones located at the apexes of a regular triangle and its geometry representation for mathematical model is given.

FIG. 2 is a schematic view of the second embodiment of the present invention, in which four microphones lined in straight and its geometry representation for mathematical model is given.

FIG. 3 is the circuit diagram of the present invention.

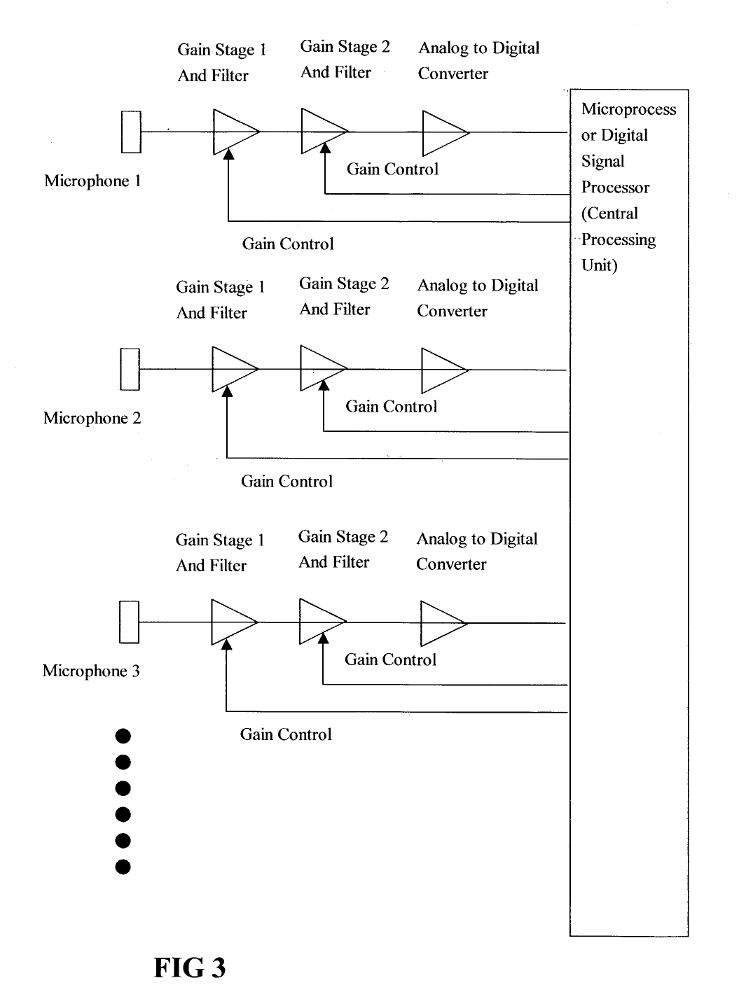

### DETAILED DESCRIPTION OF THE PREFERRED EMBODIMENT

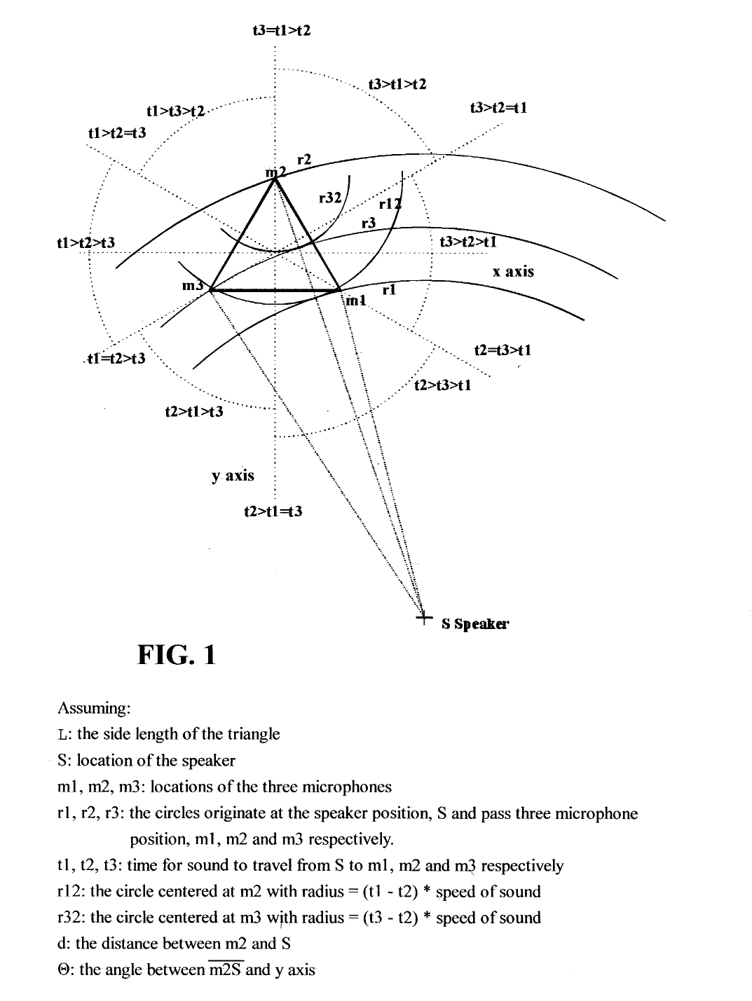

Referring to FIGS. 1, depicting the first embodiment of the present invention, the dynamic audio conference system includes three microphones located as three apexes of a regular triangle. The quality-improving method in the dynamic audio conference system is to select the most suitable microphone from a group of microphones based on the location of a speaker (S or voice source), while said location can be calculated from the time differences of the audio signal arrived in the three microphones (m1, m2, m3) due to their distances from said speaker (S). The respective audio amplifier is also applied to the selected microphone so that the gain value of the amplifier will compensate the sensitivity of the microphone due to the distance calculated.

The location of speaker (S) in term of the angle between m2S and y axis (Θ) and of the distance between m2 and S (d) could be mathematically simplified to find two circles (r1 and r2) with the following conditions:

r1 pass m1 and is tangential to r32. That is to say the distance between m2 and S is equal to the sum of r1 and r12;

r2 pass m2 and is tangential to r32. That is to say the distance between m2 and S is equal to the sum of r3 and r32;

r1 & r2 have the same origin, S;

Let d=the distance between m2 and S, then

d−r12 the distance between S and m1

d−r32=the distance between S and m2

In FIG. 1, we separate the zones surrounding the conference phone by six. For calculating Θ and d, we could use only 3 zones, i.e.: zone with t2, t3 and t1 maximum among (t1, t2 and t3) respectively.

Let m1, m2 and m3 be represented by the (x, y) coordinate system:

m1=(x1, y1)

m2=(x2, y2)

m3=(x3, y3)

From the condition, we obtain the following equations:

d−r12=((d*cos Θ−x1)²+(d*sin Θ−y1)²)^{1/2}

d−r32=((d*cos Θ−x3)²+(d*sin Θ−Y1)²)^{1/2}

They are equivalent to the following two equations:

L²−r12²+2*d*r12=2*d*x1*cos Θ+2*sin Θ*y1*d

L²−r32²+2*d*r32=2*d*x3*cos Θ+2*sin Θ*y3*d

Let

a′=(1²−r12²)/d

b′=(1²−r32²)/d

cos Θ+bsin Θ=c

Θ=cos⁻¹x

then,

x=(−2*c+−(4*c²−4*(c²−b²)(1−b²))^{1/2}/(2*(1−b²))

d=(L²−r12²)/(2*x1*cos Θ−2*y1*sin Θ−2*r12)

where

b=(2*y1*b′−2a′*y3)/(2*x1*b′−2a′*x3), and

c=(2*b′*r12−2*a′*r32)/(2*x1*b1 −2*a′*x3)

Once we know the location of the speaker (S), we could then select the suitable microphone and compensate the sensitivity loss due to the distance. Further Modeling of the Audio Traveling Time differences to Microphone Arrays is given as follows:

In FIG. 1, we further assume that

dc is the distance between S and the center of the device, i.e. the origin of the (x,y) coordinate system;

α is the angle between the x axis and the line passing S and the origin of (x,y) O;

d1 is the distance between S and m1;

d2 is the distance between S and m2;

d3 is the distance between S and m3;

then,

t1=d1/v={(d*cos α−L/2)²+(d*sin α+3^{1/2}/2*L)²}^{1/2}/v

t2=d2/v={(d*cos α)²+(d*sin α−3^{1/2}/2*L)²}^{1/2}v

t3=d3/v={(d*cos α+L/2)²+(d*sin α+3^{1/2}/2*L)²}^{1/2}/v

Given L=10 cm, α=45° and d=5 meters, we obtain

t1=0.0146542 second

t2=0.0145023 second

t3=0.0148580 second

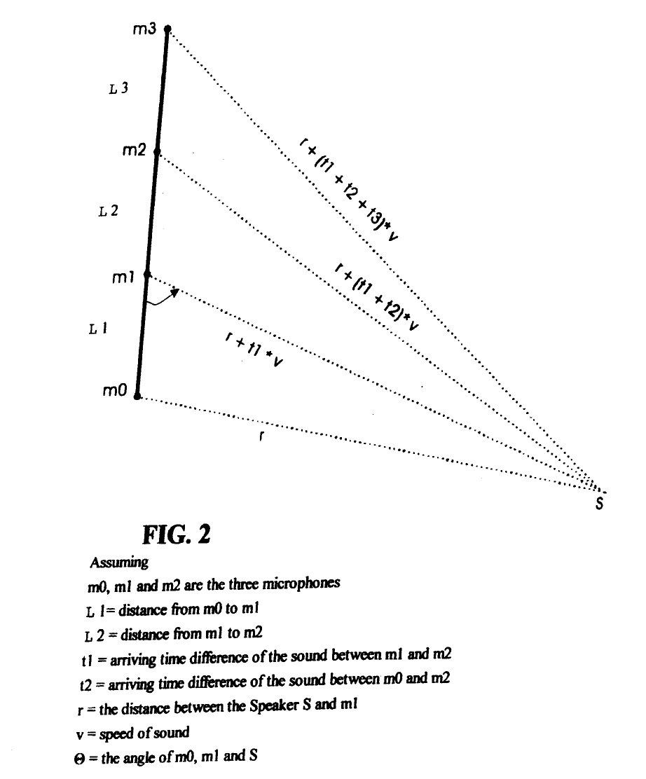

Referring to FIGS. 2, depicting the second embodiment of the present invention, the dynamic audio conference system includes 4 microphones located on a strait line. From the triangle (m1, m0, S) we obtain the equation:

r²=L1²+(r+t1*v)²−2*L1*(r+t1*v)cos Θ;

where v is the speed of sound and is about 343 meter/second at room temperature of 20° C.

From the triangle (m0, m2, S) we obtain the equation:

(r+t1*v+t2*v)²=L2²+(r+t1*v)²+2*L2*(r+t1*v)*cos Θ

From the above two equations we obtain:

r=(L2*L1²+L2²*L1+t1²*v²*L2−2*L1*t1*t2*v²−L1*t2²*v²)/(2*L1*t2*v−2*t1*v*L2)

Θ=cos ⁻¹{(r²−L1²−(r+t1*v)²)/(2*L1*(r+t11*v))

If L 1=L 2, then

r=(2*L2+t1²*v²−2*t1*t2*v²−t2*t2*v²)/(2*(t2 −t1)*v)

Θ=90°

A four-microphone system could be used to avoid the numerical errors when L 1*t2 is close to t1*L 2.

While the invention have been disclosed in connection with specific embodiments, it should be understood by those skilled in the art that these descriptions are not intended to limit the scope of the invention, and that any modification and variation without departing the spirit of the invention is intended to be covered by the scope of this invention defined by the appended claimed.

1) An audio conference system comprising:
at least three microphones, which collect analog voice signals;
a microphone array, which is consisted of said microphones with known locations; and obtain the time differences of the audio wave at the at least three microphones;
a processor, for locating the position of voice sources by calculating the time differences;
a converter, which digitizes analog signals accepted directly from said microphones;
two digital gain controls, which amplify signals due to amplitude of and distance from the voice sources; and
a digital compensation software, which controls and make compensation for the signal acquired by the processor.

2) The audio conference system as in claim 1, wherein the microphones consisted in the multiple microphone array are arranged in a triangle, a line, or multiangular geometrical configuration.

3) The audio conference system as in claim 1, wherein said converter coverts analog signals to digital signals so fast that the difference of signal receiving time from voice source to each of the microphones could be distinguished.

4) The audio conference system as in claim 1, wherein said processor deduces the location of voice source based on the difference of signal receiving time detected by said converter.

5) The audio conference system as described in claim 1, wherein said digital gain controls select a particular microphone to be compensated by said digital compensation software.

6) The audio conference system as in claim 1, wherein the processor further scheme as habitually used on the audio conference device.

7) A quality-improving method for audio conference by compensating sensitivities of microphones, comprising the following proceedings:
which collecting analog voice signals from at least three microphones; making a microphone array, which is consisted of said microphones with known locations;
digitizing analog signals immediately after accepted from said microphones by a converter, and obtaining time differences of the audio wave at the at least three microphones;
locating the position of voice sources by calculating the time differences by a processor;
amplifying signals due to amplitude of and distance from voice sources by two digital gain controls; and
making compensation for the signals acquired by the processor by a digital compensation soft wave.

8) The quality-improving method for audio conference by compensating sensitivities of microphones as in claim 7, wherein said microphones are arranged in a triangle, a line or multiangular geometrical configuration.

9) The quality-improving method for audio conference by compensating sensitivities of microphones as in claim 7, wherein said converter coverts analog signals to digital signals in such a fast manner that the difference of signal receiving time from voice source between microphones could be distinguished, which is mainly caused by difference of distance between voice source and each of the microphones.

10) The quality-improving method for audio conference by compensating sensitivities of microphones as described in claim 7, wherein said digital gain controls select particular microphone(s) to be compensated by said digital compensation software.

11) The quality-improving method for audio conference by compensating sensitivities of microphones as in claim 7, wherein the particular microphone is compensated by said digital compensation software according to original sensitivity of the microphone and the distance from voice source, which is calculated based on the arranged locations of microphones and deduced by said processor.

12) A quality-improving method for audio conference by compensating sensitivities of microphones comprising the following proceedings:
collecting analog voice signals from at least three microphones receiving a voice source;
distinguishing travel time difference from voice source to respective microphones by a high-speed analogue to digital converter;
locating the voice source by calculating the algorithm in terms of the travel time differences and representing the location of the voice source by the distance and directional angle; and
using the directional angle to calculate the necessary gain of the microphone and recover the sensitivity of the microphone(s).
